(19) United States
(12) Patent Application Publication
(10) Pub. No.: US 2009/0036567 A1
(43) Pub. Date: Feb. 5, 2009

(54) PROCESS FOR PRODUCING MODIFIED DIENE POLYMER RUBBER

(75) Inventors: Mayumi OSHIMA, Ichihara-shi (JP); Seiichi MABE, Ichihara-shi (JP); Katsunari INAGAKI, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 12/240,825

(22) Filed: Sep. 29, 2008

Related U.S. Application Data
(63) Continuation of application No. 10/995,095, filed on Nov. 24, 2004, now abandoned.

(30) Foreign Application Priority Data
Mar. 11, 2004 (JP) 2004-068697

(51) Int. Cl. C08J 5/14; C08F 8/30

(52) U.S. Cl. 523/155; 525/102

(57) ABSTRACT

There is provided a process for producing a modified diene polymer rubber comprising the steps of:
(1) polymerizing a conjugated diene monomer or a combination thereof with an aromatic vinyl monomer in a hydrocarbon solvent, in the presence of an alkali metal catalyst, to form an alkali metal end-carrying active polymer, and
(2) reacting the alkali metal end-carrying active polymer with a silane compound defined by a specific formula.

### FIELD OF THE INVENTION

The present invention relates to a process for producing a modified diene polymer rubber having excellent impact resilience. A modified diene polymer rubber produced according to said process is very suitable for producing motorcar tires having superior fuel cost saving.

### BACKGROUND OF THE INVENTION

A styrene-butadiene copolymer produced by an emulsion polymerization method has been known as a rubber used for producing motorcar tires. However, said copolymer has a problem that motorcar tires comprising said copolymer are not satisfactory from a viewpoint of fuel cost saving, because the copolymer does not have sufficient impact resilience.

In order to produce a rubber having superior impact resilience, JP 60-72907A discloses a production process, which comprises copolymerizing butadiene and styrene in a hydrocarbon solvent using an organolithium compound as an initiator, and a Lewis base such as an ether as a microstructure-controlling agent.

Also, JP 2540901B2 (corresponding to U.S. Pat. No. 5,189,109A) proposes a production process, which comprises reacting an alkali metal linked to the end of a diene polymer rubber with a specific acrylamide to produce a modified diene copolymer rubber having improved impact resilience.

Further, JP6-57767B (corresponding to U.S. Pat. No. 4,957,976A) proposes a production process, which comprises reacting an alkali metal linked to the end of a diene polymer rubber with a specific aminocarbyloxysilane to produce a modified diene copolymer rubber having improved impact resilience.

However, in recent years, a level demanded for fuel cost saving of motorcar tires has become higher from an environmental point of view, and therefore, any of the above-mentioned copolymer rubbers can hardly satisfy such a demand.

### SUMMARY OF THE INVENTION

An object of the present invention is to provide a process for producing a modified diene polymer rubber having excellent impact resilience.

The present invention is a process for producing a modified diene polymer rubber comprising the steps of:

(1) polymerizing a conjugated diene monomer or a combination thereof with an aromatic vinyl monomer in a hydrocarbon solvent, in the presence of an alkali metal catalyst, to form an alkali metal end-carrying active polymer, and

(2) reacting the alkali metal end-carrying active polymer with a compound represented by the following formula (1),

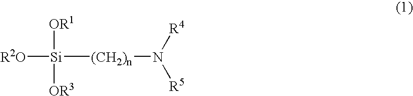

wherein R¹, R² and R³ are independently of one another an alkyl group having 1 to 4 carbon atoms; R⁴ and R⁵ are independently of each other an alkyl group having 1 to 6 carbon atoms; and n is 0 (zero) or an integer of 1 to 10.

The present invention is also a rubber composition comprising the following components (1) to (5):

(1) 10 to 100 parts by weight of a modified diene polymer rubber produced by the above-mentioned process,

(2) 0 to 90 parts by weight of other rubber,

(3) 0 to 100 parts by weight of carbon black,

(4) 5 to 100 parts by weight of silica, and

(5) 0 to 20% by weight of a silane coupling agent,

wherein a total of the components (1) and (2) is 100 parts by weight, and an amount of the component (5) is based on an amount of the component (4).

### DETAILED DESCRIPTION OF THE INVENTION

Examples of the conjugated diene monomer in the present invention are 1,3-butadiene, isoprene, 1,3-pentadiene (piperylene), 2,3-dimethyl-1,3-butadiene and 1,3-hexadiene. Among them, 1,3-butadiene or isoprene is preferable from a viewpoint of availability thereof and physical properties of a modified diene polymer rubber produced.

Examples of the aromatic vinyl monomer in the present invention are styrene, α-methylstyrene, vinyltoluene, vinylnaphthalene, divinylbenzene, trivinylbenzene and divinylnaphthalene. Among them, styrene is preferable from a viewpoint of availability thereof and physical properties of a modified diene polymer rubber produced.

The hydrocarbon solvent in the present invention is a hydrocarbon solvent, which does not deactivate the alkali metal catalyst in the present invention. Suitable examples thereof are aliphatic hydrocarbons, aromatic hydrocarbons and alicyclic hydrocarbons. Particularly preferable examples thereof are those having 2 to 12 carbon atoms. Specific examples thereof are propane, n-butane, iso-butane, n-pentane, iso-pentane, n-hexane, cyclohexane, propene, 1-butene, iso-butene, trans-2-butene, cis-2-butene, 1-pentene, 2-pentene, 1-hexene, 2-hexene, benzene, toluene, xylene and ethylbenzene, and a combination of two or more thereof.

The alkali metal catalyst in the present invention means an alkali metal, a hydrocarbon compound having a chemical bond with the alkali metal, or a complex compound of the alkali metal with a polar compound.

Examples of the above-mentioned alkali metal are lithium, sodium, potassium, rubidium and cesium.

Examples of the above-mentioned hydrocarbon compound having a chemical bond with the alkali metal are ethyllithium, n-propyllithium, iso-propyllithium, n-butyllithium, sec-butyllithium, tert-octyllithium, n-decyllithium, phenyllithium, 2-naphthyllithium, 2-butyl-phenyllithium, 4-phenyl-butyllithium, cyclohexyllithium, 4-cyclopentyllithium, 1,4-dilithio-butene-2, sodium naphthalene, sodium biphenyl, and a sodium salt of an α-methylstyrene tetramer. Among them, preferred is a hydrocarbon compound, which has 2 to 20 carbon atoms, and has a chemical bond with lithium or sodium.

Examples of the above-mentioned complex compound of the alkali metal with a polar compound are a potassium-tetrahydrofuran complex and a potassium diethoxyethane complex.

In the formula (1), R¹, R² and R³ are the same as, or different from one another. These three groups are preferably the same from a viewpoint of a synthetic route of a compound represented by the formula (1). These three groups are preferably a methyl group or an ethyl group. In the formula (1), R⁴ and R⁵ are the same as, or different from each other. These two groups are preferably the same from a viewpoint of a synthetic route of a compound represented by the formula (1). These two groups are preferably a methyl group or an ethyl group.

In the formula (1), n is preferably 3 or 4 in view of a high improvement of fuel cost saving, and a relatively easy productivity of a compound represented by the formula (1).

Examples of the compound represented by the formula (1) are [3-(dimethylamino)propyl]trimethoxysilane, [3-(diethylamino)propyl]trimethoxysilane, [3-(dimethylamino)propyl]triethoxysilane, [3-(diethylamino)propyl]triethoxysilane, [(3-methyl-3-ethylamino)propyl]trimethoxysilane, and [(3-methyl-3-ethylamino)propyl]triethoxysilane. Among them, preferred is [3-(diethylamino)propyl]trimethoxysilane or [3-(dimethylamino)propyl]triethoxysilane from a viewpoint of a remarkable improvement of fuel cost saving.

When a combination of the conjugated diene monomer with the aromatic vinyl monomer is used in the present invention, a ratio by weight of the former monomer to the latter monomer (namely, conjugated diene monomer/aromatic vinyl monomer) is preferably 50/50 to 90/10, and further preferably 55/45 to 85/15. When said ratio is less than 50/50, the alkali metal end-carrying active polymer produced in the step (1) is insoluble in a hydrocarbon solvent, and as a result, a homogeneous polymerization may be impossible in the step (1). When said ratio is more than 90/10, the produced modified diene polymer rubber may be low in its strength. A copolymer of the conjugated diene monomer with the aromatic vinyl monomer produced using the above-mentioned combination is preferably a random copolymer from a viewpoint of an improvement of fuel cost saving. When said copolymer is a block copolymer, a vulcanized rubber thereof may be low in its fuel cost saving.

Each of the conjugated diene monomer and the aromatic vinyl monomer in the present invention may be combined with (i) a randomizer, or (ii) a compound used for controlling a content of a vinyl bond (which is derived from the conjugated diene monomer) contained in the produced modified diene polymer rubber. A mode of polymerization in the present invention is not particularly limited.

An example of the above-mentioned compound used for controlling a content of a vinyl bond is a Lewis basic compound. Said compound is preferably an ether or a tertiary amine from a viewpoint of industrial availability.

Examples of the above-mentioned ether are a cyclic ether such as tetrahydrofuran, tetrahydropyran and 1,4-dioxane; an aliphatic mono ether such as diethyl ether and dibutyl ether; an aliphatic diether such as ethylene glycol dimethyl ether, ethylene glycol diethyl ether, ethylene glycol dibutyl ether, diethylene glycol diethyl ether and diethylene glycol dibutyl ether; and an aromatic ether such as diphenyl ether and anisole.

Examples of the above-mentioned tertiary amine are triethylamine, tripropylamine, tributylamine, N,N,N′,N′-tetramethylethylenediamine, N,N-diethylaniline, pyridine and quinoline.

The compound represented by the formula (1) in the step (2) is used in an amount of usually 0.1 to 10 mol, and preferably 0.5 to 2 mol, per 1 mol of the alkali metal catalyst. When said amount is less than 0.1 mol, an improving effect of fuel cost saving may be small. When said amount is more than 10 mol, the compound represented by the formula (1) remains unreacted in the solvent. It is not preferable from an economical point of view, because an additional step of separating said compound from the solvent is required in order to recycle and reuse the solvent.

The reaction in the step (2), namely, the reaction of the compound represented by the formula (1) with the alkali metal end-carrying active polymer produced in the step (1), proceeds rapidly even at a room temperature. A preferable example of a method for contacting said compound with said active polymer is a method comprising the step of adding said compound to the polymerization reaction mixture produced in the step (1).

From a viewpoint of processability while kneading of the modified diene polymer rubber produced, it is permitted to add a coupling agent represented by the following formula to said active polymer, before or after the reaction in the step (2):

RₐMX₄₋ₐ

wherein R is an alkyl group, an alkenyl group, a cycloalkenyl group or an aromatic hydrocarbon group; M is a silicon atom or a tin atom; X is a halogen atom; and a is an integer of from 0 to 2.

The above-mentioned coupling agent is added in an amount of usually 0.03 to 0.4 mol, and preferably 0.05 to 0.3 mol, per 1 mol of the alkali metal catalyst. When said amount is less than 0.03 mol, an improving effect of processability of the produced modified diene polymer rubber may be small. When said amount is more than 0.4 mol, a proportion of the above-mentioned active polymer reacting with the compound represented by the formula (1) decreases, so that an improving effect of fuel cost saving may decrease.

The modified diene polymer rubber contained in the reaction mixture produced in the step (2) can be solidified according to a solidifying method, which is usually carried out for producing a rubber by a solution polymerization method, such as (1) a method comprising the step of adding a coagulant, and (2) a general method comprising the step of adding steam. A solidifying temperature is not particularly limited.

The solidified modified diene polymer rubber is separated, and then dried with a drier known in the art such as a band drier and an extrusion type drier, which are commonly used in a synthetic rubber production. A drying temperature is not limited.

A Mooney viscosity (ML₁₊₄100° C.) of the produced modified diene polymer rubber is preferably 10 to 200, and more preferably 20 to 150. When said viscosity is less than 10, mechanical properties such as tensile strength of its vulcanized rubber may decrease. When said viscosity is more than 200, its miscibility with other rubber may be so poor, when blending said modified diene polymer rubber with said other rubber in order to produce a rubber composition, that it is difficult to produce said rubber composition, and as a result, mechanical properties of its vulcanized rubber composition may decrease.

A content of a vinyl bond (which is derived from the conjugated diene monomer) contained in the produced modified diene polymer rubber is preferably from 10 to 70%, and more preferably from 15 to 60%. When said content is less than 10%, a glass transition temperature of the produced modified diene polymer rubber may be lowered, and as a result, a grip performance of motorcar tires composed of the modified diene polymer rubber mat be deteriorated. When said content is more than 70%, a glass transition temperature of the produced modified diene polymer rubber may be elevated, and as a result, an impact resilience of the modified diene polymer rubber may be deteriorated.

The produced modified diene polymer rubber can be used as a rubber composition in combination with other components such as other rubbers and various additives.

Examples of said other rubber are a styrene-butadiene copolymer rubber produced by an emulsion polymerization method; a polybutadiene rubber, a butadiene-isoprene copolymer rubber and a tyrene-butadiene copolymer rubber produced by a solution polymerization method using a catalyst such as an anion polymerization catalyst and a Ziegler type catalyst; and a natural rubber; and a combination of two or more thereof.

As to the above-mentioned rubber composition comprising the modified diene polymer rubber produced by the process according to the present invention and other rubber, a proportion of the former rubber is preferably 10% by weight or more, and more preferably 20% by weight or more, wherein the total of both rubbers is 100% by weight. When said proportion is less than 10% by weight, an impact resilience of the produced rubber composition may hardly be improved, and its processability is not good.

A kind and an added amount of the above-mentioned additives may be determined depending upon purposes of using the produced rubber composition. Examples of the additives usually employed in a rubber industry are vulcanizing agents such as sulfur; stearic acid; zinc white; thiazol type vulcanization accelerators; vulcanization accelerators such as thiuram type vulcaniztion accelerators and sulfenamide type vulcanization accelerators; organic peroxides; reinforcing agents such as carbon black of HAF and ISAF grades; fillers such as silica, calcium carbonate and talc; extender oils; processing coagents; and antioxidants. Each of carbon black and silica is added in an amount of preferably from 10 to 150 parts by weight, wherein the total amount of the modified diene polymer rubber, or a combination thereof with the above-mentioned other rubber is 100 parts by weight. When said amount is less than 10 parts by weight, a reinforcing effect on a rubber component may be insufficient. When said amount is more than 150 parts by weight, the produced rubber composition may be low in its elongation.

A process for producing the above-mentioned rubber composition is not limited. An example thereof is a process comprising the step of mixing respective components in a mixer known in the art such as a roll and a Bambury mixer. The produced rubber composition is usually vulcanized, and is used as a vulcanized rubber composition.

Since the modified diene polymer rubber produced by the process in accordance with the present invention is superior in its impact resilience and processability, a rubber composition comprising said modified diene polymer rubber is most suitable for motorcar tires having superior fuel cost saving. Said rubber composition can also be employed for uses such as soles for shoes, floor materials and rubber vibration insulators.

### EXAMPLES

The present invention is explained with reference to the following Example, which does not limit the scope of the present invention.

### Example 1

A 20 liter-inner volume stainless steel polymerization reactor was washed and dried, and thereafter purged with dry nitrogen. To the reactor, 1404 g of 1,3-butadiene, 396 g of styrene, 122 g of tetrahydrofuran, 10.2 kg of hexane and 11.0 mmol of n-butyllithium (n-hexane solution) were added, and polymerization was carried out at 65° C. for 3 hours under stirring, thereby obtaining a polymerization mixture.

To the polymerization mixture, 11.0 mmol of [3-(diethylamino)propyl]trimethoxysilane was added, and the obtained mixture was reacted at 65° C. for 60 minutes under stirring. To the obtained reaction mixture, 10 ml of methanol was added, and the obtained mixture was further stirred for 5 minutes, thereby obtaining a reaction mixture.

The reaction mixture was taken out and mixed with 10 g of 2,6-di-t-butyl-p-cresol, a trade name of SUMILIZER BHT, manufactured by Sumitomo Chemical Co., Ltd. Thereafter, most of hexane was evaporated, and successively the remainder was dried under a reduced pressure at 55° C. for 12 hours, thereby obtaining a modified diene polymer rubber.

### Comparative Example 1

Example 1 was repeated to obtain a polymer rubber, except that (i) the added amount of n-butyllithium (n-hexane solution) was changed from 11.0 mmol to 8.91 mmol, (ii) 0.45 mmol of stannic chloride (coupling agent) was added, and (iii) [3-(diethylamino)propyl]trimethoxysilane was not added.

### Comparative Example 2

Example 1 was repeated to obtain a polymer rubber, except that (i) the added amount of n-butyllithium (n-hexane solution) was changed from 11.0 mmol to 10.0 mmol, and (ii) 11.0 mmol of [3-(diethylamino)propyl]trimethoxysilane was changed to 10.0 mmol of [3-(dimethylamino)propyl]diethoxymethylsilane.

The following measurements were made on the modified diene polymer rubber obtained in Example 1 and the polymer rubbers obtained in Comparative Examples 1 and 2. Results are shown in Table 1.

1. Mooney Viscosity

It was measured at 100° C. according to JIS K-6300, wherein “JIS” means “Japanese Industrial Standards”.

2. Content of Vinyl Group (% by mol)

It was measured according to an infrared spectroscopic analysis.

3. Content of Styrene Unit (% by weight)

It was measured according to a refractive index method.

4. Coupling Ratio (%)

It was measured by a method comprising the steps of:

(1) measuring a curve of a gel permeation chromatography, and

(2) measuring an area (A_{H}) corresponding to a high molecular portion and an area (A_{L}) corresponding to a low molecular portion contained in the curve, respectively, and

(3) obtaining a ratio of A_{H} to A_{L}, which is a coupling ratio.

5. Impact Resilience of Vulcanized Rubber (@60° C., %)

Impact resilience shown in Table 1 was measured by a method comprising the steps of:

(1) kneading 100 parts by weight of the modified diene polymer rubber or the polymer rubber and components shown in Table 2 in a laboplastomil to obtain a kneaded product,

(2) molding the kneaded product with a 6-inch roll into a sheet,

(3) vulcanizing the sheet by heating at 160° C. for 45 minutes to obtain a vulcanized sheet, and

(4) measuring a 60° C. impact resilience of the vulcanized sheet with a Luepke resilience tester.

TABLE 1

| | | Comparative Example | |
|---|---|---|---|
| | Example 1 | 1 | 2 |
| Compound represented by the | Note 1 | — | Note 2 |
| formula (1) | | | |
| Mooney viscosity(ML₁₊₄100° C.) | 59 | 69 | 48 |
| Vinyl group content($ by mol) | 58 | 58 | 60 |
| Styrene unit content (% by | 23 | 22 | 23 |
| weight) | | | |
| Coupling ratio (%) | 0 | 0 | 0 |
| Impact resilience (@60° C., %) | 65 | 56 | 59 |

Note 1:
[3-(diethylamino)propyl]trimethoxysilane
Note 2:
[3-(dimethylamino)propyl]diethoxymethylsilane

TABLE 2

| | Blending ratio |
|---|---|
| Components | (part by weight) |
| Modified diene polymer rubber or polymer rubber | 100 |
| Silica(Note 1) | 78.4 |
| Silane coupling agent(Note 2) | 6.4 |
| Carbon | 6.4 |
| Extender oil(Note 3) | 47.6 |
| Antioxidant(Note 4) | 1.5 |
| Zinc white | 2 |
| Vulcanization accelerator(note 5) | 1 |
| Vulcanization accelerator(Note 6) | 1 |
| Wax(Note 7) | 1.5 |
| Sulfur | 1.4 |

(Note 1):
Trademark of ULTRASIL VN3-G, manufactured by Degussa.
(Note 2):
Si69 manufactured by Deggusa.
(Note 3):
Aroma oil, trademark of X-140, manufactured by Kyodo Oil Co., Ltd.
(Note 4):
Antioxidant, trademark of ANTIGEN 3C, manufactured by Sumitomo Chemical Co., Ltd.
(note 5):
Vulcanization accelerator, trademark of SOXINOL CZ, manufactured by Sumitomo Chemical Co., Ltd.
(Note 6):
Vulcanization accelerator, trademark of SOXINOL D, manufactured by Sumitomo Chemical Co., Ltd.
(Note 7):
Trademark of SUNNOC N, manufactured by Ouchishinko Chemical Industrial Co., Ltd.

1. A process for producing a modified diene polymer rubber comprising the steps of:
(1) polymerizing a conjugated diene monomer or a combination thereof with an aromatic vinyl monomer in a hydrocarbon solvent, in the presence of an alkali metal catalyst, to form an alkali metal end-carrying active polymer, and
(2) reacting the alkali metal end-carrying active polymer with a compound represented by the following formula (1), 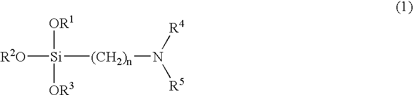
wherein R¹, R² and R³ are independently of one another an alkyl group having 1 to 4 carbon atoms;
R⁴ and R⁵ are independently of each other an alkyl group having 2 to 6 carbon atoms; and
n is 0 (zero) or an integer of 1 to 10.

2. The process for producing a modified diene polymer rubber according to claim 1, wherein all of R¹, R² and R³ are a methyl group or an ethyl group.

3. A rubber composition comprising the following components (1) to (5):
(1) 10 to 100 parts by weight of a modified diene polymer rubber produced by the process according to claim 1,
(2) 0 to 90 parts by weight of other rubber,
(3) 0 to 100 parts by weight of carbon black,
(4) 5 to 100 parts by weight of silica, and
(5) 0 to 20% by weight of a silane coupling agent,
wherein a total of the components (1) and (2) is 100 parts by weight, and an amount of the component (5) is based on an amount of the component (4).

4. (canceled)

5. (canceled)

6. The process for producing a modified diene polymer rubber according to claim 1, wherein both R⁴ and R⁵ are ethyl groups.

7. The process for producing a modified diene polymer rubber according to claim 1, wherein n is 3 or 4.
